(19) United States
(12) Patent Application Publication
(10) Pub. No.: US 2002/0176908 A1
(43) Pub. Date: Nov. 28, 2002

(54) Electric direct-acting die clamping unit of an injection molding machine

(76) Inventors: Akira Yoshinaga, Numazu-shi (JP); Jun Koike, Shizuoka-ken (JP); Tatsuhiko Maru, Numazu-shi (JP); Fumiyuki Kato, Shizuoka-ken (JP); Makoto Nishizawa, Numazu-shi (JP)

Correspondence Address: Pillsbury Winthrop LLP, 1600 Tysons Boulevard, McLean, VA, 22102, US

(21) Appl. No.: 10/128,318

(22) Filed: Apr. 24, 2002

(30) Foreign Application Priority Data
May 22, 2001 (JP) 2001-152806

(51) Int. Cl. B29C 45/66

(52) U.S. Cl. 425/589; 425/451.7

(57) ABSTRACT

An object of the present invention is to provide an electric direct-acting die clamping unit of an injection molding machine whose entire length can be reduced. A movable platen is arranged to face a stationary platen. A stationary die is attached to the stationary platen, whereas a movable die is attached to the movable platen. The movable platen is connected to the front of the backup plate. A nut of a ball screw is fixed at each of diagonally-opposed corners of the backup plate. The threaded rod of the ball screw passes through the backup plate via the nut. The tip portion of the threaded rod is rotatably connected to the stationary platen. The rear end portion of the threaded rod is threaded through a support plate via the bearing and connected to a motor.

### CROSS-REFERENCE TO RELATED APPLICATIONS

This application is based upon and claims the benefit of priority from the prior Japanese Patent Application No. 2001-152806, filed May 22, 2001, the entire contents of which are incorporated herein by reference.

### BACKGROUND OF THE INVENTION

1. Field of the Invention

The present invention relates to a die clamping unit of an injection-molding machine, and more specifically, to the structure of an electric direct-acting die clamping unit directly transmitting thrust from a driving source to a movable platen without using a toggle mechanism.

2. Description of the Related Art

FIG. 6 shows a schematic structure of a conventional electric direct-acting die clamping unit.

A stationary platen 3 and a housing 32 are arranged at both ends of a base 1 so as to face each other. A movable platen 4 is arranged in the front of the housing 32 so as to face the stationary platen 3. A stationary die 5 is attached to the front surface of the stationary platen 3, whereas a movable die 6 is attached to the front surface of the movable platen 4.

The housing 32 and the stationary platen 3 are connected by four tie rods 37. A through-hole is formed at each of the four corners of the movable platen 4. The four tie rods 37 are passed through the corresponding through-holes. The movable platen 4 slides back and forth along the tie rods 37, that is, in the die clamping and unclamping directions.

The movable platen 4 is connected to the front surface of the housing 32 via a ball screw 40. More specifically, a load cell 45 is fixed to the back surface of the movable platen 4. The tip portion of the threaded rod 41 of the ball screw is fixed to the back surface of the load cell 45. The nut 42 of the ball screw is rotatably supported by the housing 32 via a bearing 47.

A motor 50 is arranged under the base 1. A pulley 52 is attached to the end surface (at the side close to the movable die) of the nut 42 of the ball screw. Another pulley 51 is attached to the shaft of the motor 50. A timing belt 53 goes around the two pulleys 51 and 52. When the motor 50 rotates the nut 42, the threaded rod 41 moves back and forth along its axis, thereby moving the movable platen 4 back and forth along the tie rods 37.

As mentioned above, in the conventional electric direct-acting die clamping unit, the movable platen 4 is moved by means of the ball screw 40 to clamp and unclamp the dies.

(A problem of a conventional direct-acting die clamping unit)

Since the threaded rod 41 of the ball screw is moved backward together with the movable platen 4 in the conventional unit when dies are unclamped, a space must be provided at the back of the housing 32. Therefore, the entire length of the unit becomes inevitably long.

### BRIEF SUMMARY OF THE INVENTION

The present invention has been made in view of the problems associated with a conventional electric direct-acting die clamping unit. An object of the present invention is to provide an electric direct-acting die clamping unit whose entire length can be reduced.

According to the present invention, there is provided an electric direct-acting die clamping unit of an injection molding machine, comprising:

a stationary platen holding a stationary die;

a movable platen arranged so as to face the stationary platen and holding a movable die;

a backup plate supporting the movable platen from the back surface;

a plurality of ball screws, which connects between the stationary platen and the backup plate; a tip of the threaded rod of each of the ball screws being rotatably connected to the stationary platen and the nut of each of the ball screws being fixed to the backup plate; and

a motor rotating the threaded rods of the plurality of ball screws synchronously with each other.

In the electric direct-acting die clamping unit according to the present invention, the backup plate is moved along the threaded rods of the ball screws by rotating the threaded rods. Accordingly, the movable platen moves back and forth to clamp and unclamp the dies. At this time, the threaded rods of the ball screws only rotate and do not move. Therefore, it is not necessary to leave a space at the back of the unit to allow the threaded rods to move backward. As a result, it is possible to reduce the entire length of the unit compared to a conventional electric direct-acting die clamping unit.

Note that the threaded rods of the ball screws may also be used as tie-rods (designated by reference numeral 37, FIG. 6) used in the conventional die-clamping unit to simplify the structure of the unit.

Preferably, the stationary platen and the backup plate are connected by two ball screws, which are arranged symmetrically to the center axis of the stationary die and the movable die and arranged at difference heights.

If two ball screws thus arranged are used as tie-rods, the number of parts arranged around the dies can be reduced. As a result, the operator can more easily get access to the dies, compared to a conventional machine.

Note that the backup plate and the movable platen can be integrally formed into one body.

### BRIEF DESCRIPTION OF THE SEVERAL VIEWS OF THE DRAWING

FIG. 1 is a view showing a schematic structure of an electric direct-acting die clamping unit of the present invention;

FIG. 2 is a sectional view showing the schematic structure of the electric direct-acting die clamping unit of the present invention, taken along the threaded rod of FIG. 1;

FIG. 3 is a detail view showing the connecting portion between a motor and the threaded rods;

FIG. 4 is a sectional view showing a part of a ball screw, taken along the IV-IV line of FIG. 3;

FIG. 5 is a sectional view of another electric direct-acting die clamping unit of the present invention, taken along the threaded rod; and

FIG. 6 is a schematic view showing a schematic structure of a conventional electric direct-acting die clamping unit.

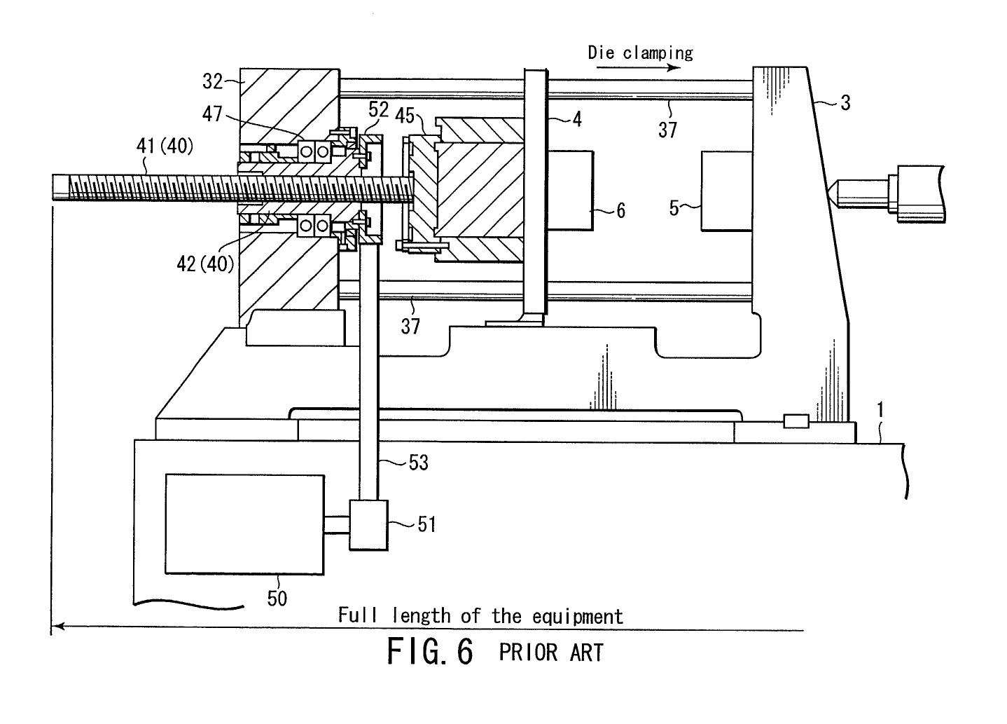

### DETAILED DESCRIPTION OF THE INVENTION

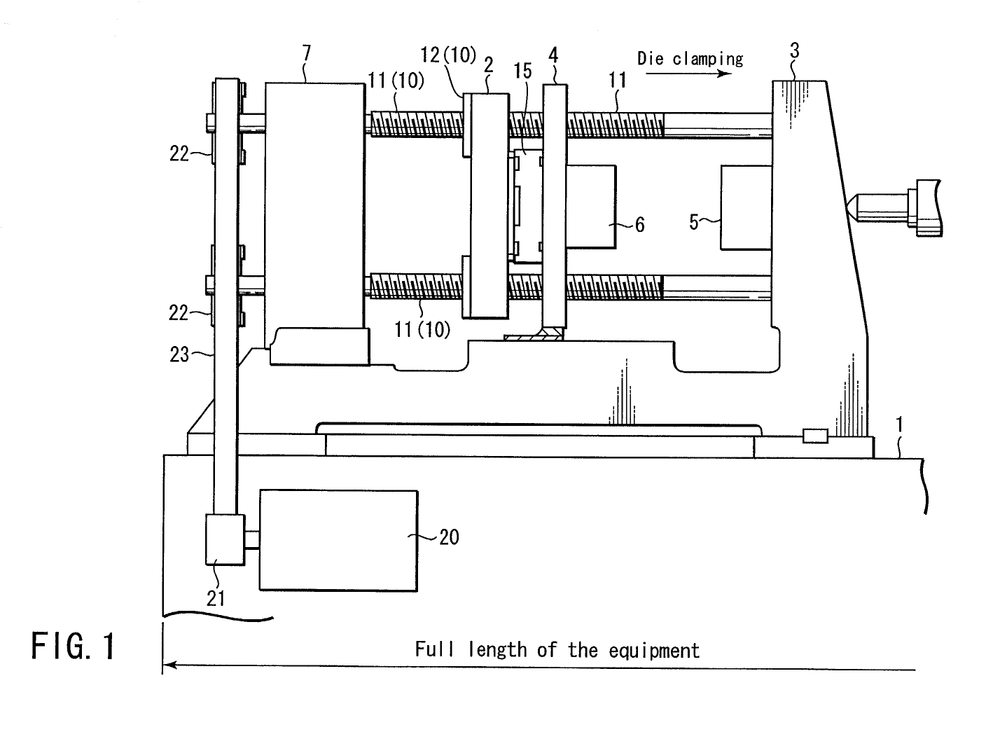

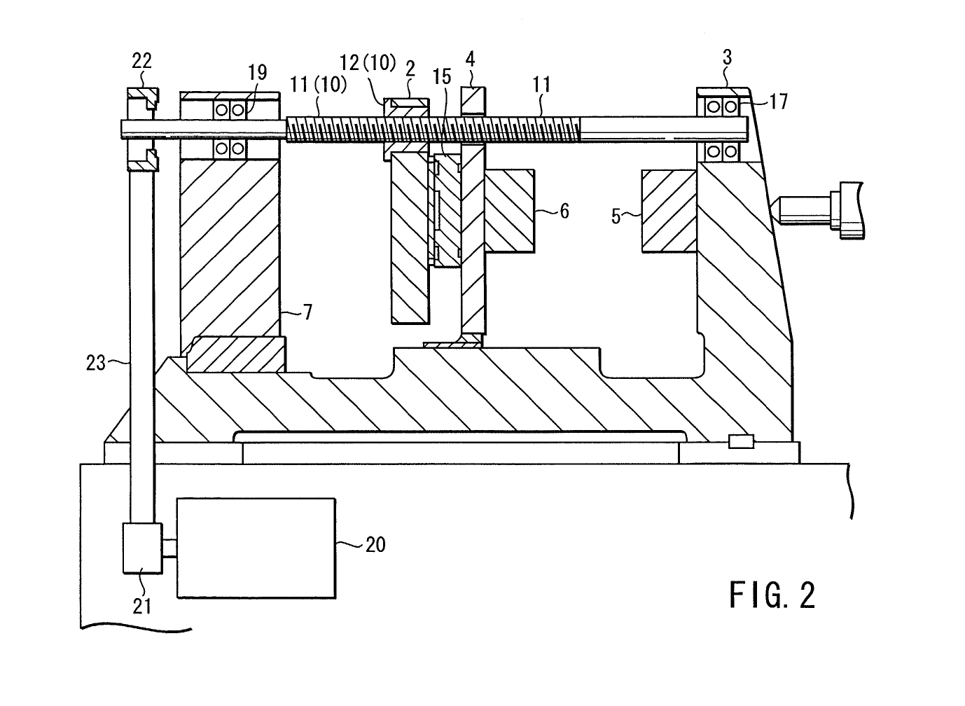

FIGS. 1 and 2 show schematic structures of the electric direct-acting die clamping unit of an injection-molding machine according to the present invention. FIG. 1 is a front view of the unit and FIG. 2 is a cross sectional view of the unit taken along the threaded rod. The unit shown in the figures has a stationary platen 3, a movable platen 4, a stationary die 5, a movable die 6, a backup plate 2, a ball screw 10, a threaded rod 11 of the ball screw, and a nut 12 of the ball screw.

The stationary platen 3 and a support plate 7 are respectively arranged at both ends of a base 1 so as to face each other. The movable platen 4 is arranged in the front of the stationary platen 3 so as to face the stationary platen 3. The stationary die 5 is attached to the front surface of the stationary platen 3, whereas the movable die 6 is attached to the front surface of the movable platen 4. The movable platen 4 is designed to slide on the base 1.

The backup plate 2 is arranged between the support plate 7 and movable platen 4. The backup plate 2 is designed to move back and forth (left and right in the figure) on the base 1. The nut 12 of each of the ball screws 10 is fixed at each of the two corners of the back plate 2 on the diagonal line. The threaded rod 11 of each of the ball screws 10 passes through the backup plate 2 via the nut 12. The tip portion (right end, in the figure) of each of the threaded rods 11 is rotatably connected to the stationary platen 3. On the other hand, the rear end (left end, in the figure) of each of the threaded rods 11 is rotatably supported by the support plate 7 and passes through the support plate 7. To the front surface of the backup plate 2, the movable platen 4 is connected via the load cell 15.

A motor 20 is arranged under the base 1. A pulley 22 is attached to the rear end portion (left end, in the figure) of the threaded rod 11 of each of the ball screws. A pulley 21 is attached to the shaft of the motor 20. A timing belt 23 goes around the pulleys 21 and 22, as described later.

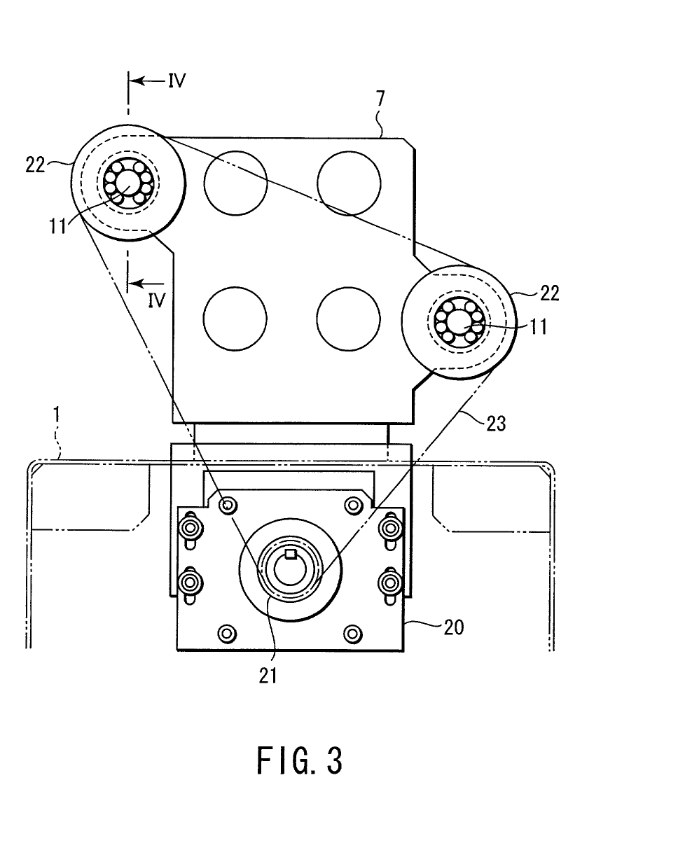

FIG. 3 (left side view) shows the detail of the connecting portion between the motor 20 and threaded rod 11. The pulley 22 is attached to the rear end portion of the threaded rod 11 of each of ball screws. On the other hand, the pulley 21 is attached to the shaft of the motor 20. A timing belt 23 goes around the pulleys 21 and 22.

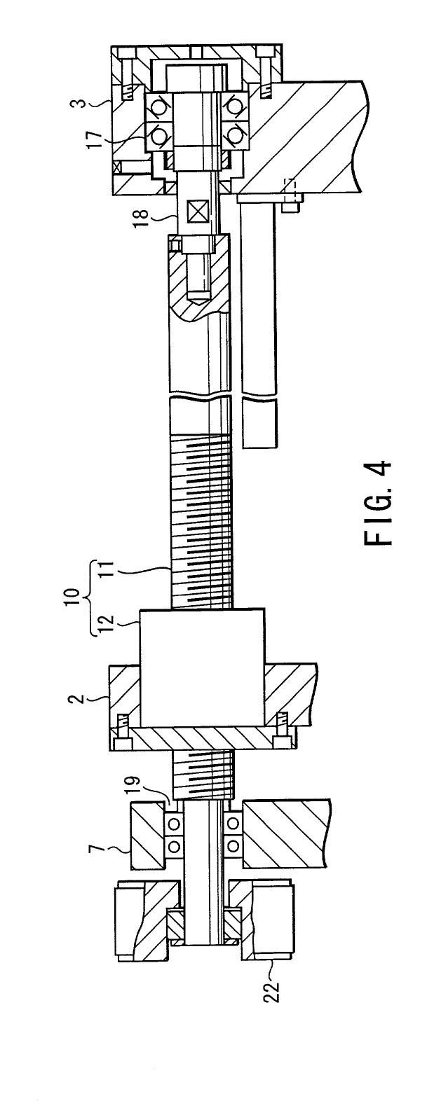

FIG. 4 shows a fragmentary view of the ball screw 10, taken along the line IV-IV of FIG. 3. The nut 12 of the ball screw 10 is fixed on the backup plate 2. The threaded rod 11 of the ball screw 10 passes through the backup plate 2 via the nut 12. The tip portion (right end in the figure) of the threaded rod 11 of the ball screw 10 is rotatably connected to the front surface of the stationary platen 3 via a bearing 17 and a fixing member 18. The rear end portion (left end in the figure) of the threaded rod 11 is rotatably supported by the support plate 7 via a bearing 19 and passes trough the support plate 7. The pulley 22 is attached to the rear end portion of the threaded rod 11.

When the threaded rods 11 are rotated by the motor 20, the nuts 12 move along the threaded rods 11. Accordingly, the backup plate 2 moves back and forth along the threaded rods 11. Along with the movement of the backup plate 2, the movable platen 4 moves, which is connected to the front surface of the backup plate 2. As mentioned above, the clamping and unclamping operation is performed by moving the ball screws 10.

When dies are clamped, a ball screws 10 are rotated to move the movable platen 4 toward the stationary platen 3. As a result, the stationary die 5 comes into contact with the movable die 6. At this time, the reaction force against the clamping force (compressive stress applied to the die surfaces) is applied to the threaded rods 11 by way of the load cell 15 and the backup plate 2.

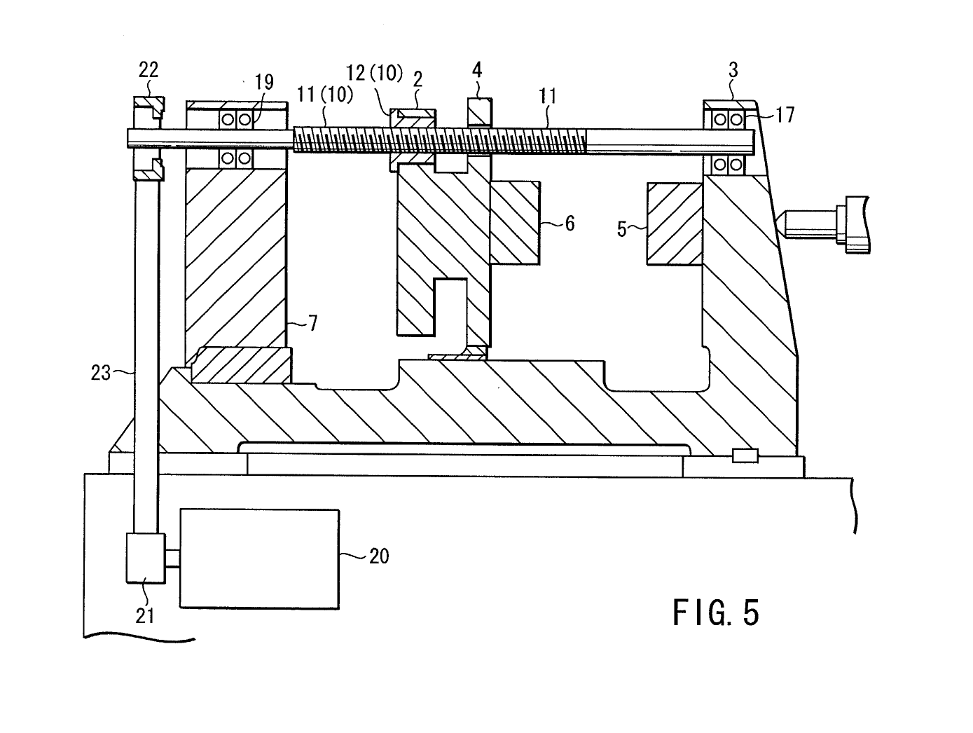

If it is possible to omit the load cell 15, the movable platen 4 can be directly connected to the front of the backup plate 2. In this case, the backup plate 2 and the movable platen 4 can be formed integrally into one body as shown in FIG. 5.

According to the electric direct-acting die clamping unit of the present invention, the threaded rods only rotate but do not move along its axis. It is therefore unnecessary to leave a space at the back of the unit to allow the threaded rods to move backward.

Furthermore, the stationary platen and the backup plate can be connected by two ball screws, which are arranged symmetrically to the center axis of the stationary die and the movable die and arranged at different heights. With this structure, the number of parts arranged around the dies can be reduced. As a result, the operator can more easily get access to the dies.

What is claimed is:

1. An electric direct-acting die clamping unit of an injection molding machine, comprising:
a stationary platen holding a stationary die;
a movable platen arranged so as to face the stationary platen and holding a movable die;
a backup plate supporting the movable platen from the back surface;
a plurality of ball screws, which connects between the stationary platen and the backup plate; a tip of the threaded rod of each of the ball screws being rotatably connected to the stationary platen and the nut of each of the ball screws being fixed to the backup plate; and
a motor rotating the threaded rods of the plurality of ball screws synchronously with each other.

2. An electric direct-acting die clamping unit of the injection molding machine according to claim 1, wherein said stationary platen and the backup plate are connected by two ball screws, which are arranged symmetrically to the center axis of the stationary die and the movable die and arranged at different heights.

3. An electric direct-acting die clamping unit of an injection molding machine according to claim 1, wherein the backup plate and the movable platen are integrally formed into one body.
